(19) United States
(12) Patent Application Publication
(10) Pub. No.: US 2003/0056172 A1
(43) Pub. Date: Mar. 20, 2003

(54) Method and system for mapping dialog definitions to multiple media

(76) Inventors: Brane Vukelic, Ottawa (CA); Gerald Lalonde, Gloucester (CA); Christopher J. M. Turnbull, Rockliffe (CA); Michael C. J. Cowpland, Rockliffe (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/953,132

(22) Filed: Sep. 17, 2001

(51) Int. Cl. G06F 17/00

(52) U.S. Cl. 715/512

(57) ABSTRACT

A system and method for automated medium independent notification of a user is disclosed herein. In an embodiment of the invention, the system allows multiple transmission media to be used to transmit the same message to a user, and allows a user to reply to the notification system using a one of many distribution media. Methods for transmitting the same notification over a variety of media, and for replying to the notification over a variety of media are also disclosed.

### FIELD OF THE INVENTION

The present invention relates to automated notification systems. In particular, the present invention relates to an automated notification system for use over a number of media, with the option for user interactivity.

### BACKGROUND OF THE INVENTION

In the field of automated notification systems, it is common for a notification to be transmitted to a user when a predetermined condition has been satisfied. The satisfaction of the condition causes an automated message to be rendered in a predetermined format for transmission to a user. For example, a notification can be sent to a user via e-mail when a predetermined stock exceeds a given price. The e-mail may have a hypertext markup language (HTML) link to encourage the user to login to a server to initiate a transaction, but at that point interaction between the user and the notification system typically ceases.

Conventional systems of this sort are designed to generate specifically formatted messages. Thus the arrival of a new distribution medium necessitates the development of new distribution medium specific software. With the arrival of wireless devices, and the desire to avoid duplicating an existing HTML based infrastructure, many systems were designed to translate the existing HTML pages, rendered by conventional systems, into wireless markup language (WML). There are two disadvantages to a conventional translation phase. The first disadvantage is that the root format, such as HTML in the previous example, defines a fixed feature set. Any secondary format, created by a translation engine, cannot exceed the feature set of the root format. The second disadvantage is that due to the formatting inherent in a conventional root language such as HTML, translation is typically limited to similar languages. Thus HTML can be translated to a similar language such as WML, which is a subset of the HTML feature set, but it is not possible to create a translator from HTML to many proprietary languages, nor is it possible to create a translator that would enable features that HTML does not support.

In a conventional notification system, there is no interaction with the user, only unidirectional transmissions. This is largely due to the difficulty of creating numerous bi-directional translators that cannot take full advantage of the feature set of the medium. Thus, conventional systems do not offer the ability to ensure that a user acts upon the information, nor do they ensure that the notification has been received. For example, a purchasing manager may be interested in alerts that are delivered by pager notification that indicate inventories of selected products are low at a critical sales time. If no response is taken to the pager notification, it may be desired that an interactive voice response system (IVR) call a cellular phone. If no reply to the IVR notification is received another individual can be notified by e-mail. Thus multiple media, over which the message can be transmitted, may be necessary for a single message, with each media requiring a different set of commands and formatting for the message to be relayed. Additionally interactivity with the user is required to ensure that the message has been received and acted upon. This cannot be accomplished by traditional systems.

It is therefore desirable to provide an automated notification system capable of interacting with a user. It is further desirable to provide an automated notification system that can render messages to a variety of independent media.

### SUMMARY OF THE INVENTION

It is an object of the present invention to obviate or mitigate at least one disadvantage of the prior art.

In a first aspect, the present invention provides a method of medium independent automated notification of a user comprised of the steps of determining, on the basis of at least one trigger, that a notification message should be transmitted, generating a medium independent description of a notification message based upon the state of the at least one trigger, selecting the medium in which the notification message should be transmitted, translating the medium independent description into a medium dependent description, and transmitting the medium dependent description to the user via the transmission channel suitable for transmitting the medium dependent description. In an embodiment of the first aspect of the present invention, the selection of the medium dependent description is done based upon a predetermined profile, wherein said profile may be specific to the user for whom the automated notification is destined, and the medium dependent description is specific to the channel on which it is transmitted. The step of determining that a notification message should be transmitted, may be optionally done on the basis of a plurality of triggers, which may be independent of each other. In a presently preferred embodiment of the first aspect the medium independent description is defined by an extensible markup language.

According to a further aspect of the present invention, there is provided a method of interactive medium independent, automated notification comprising the steps of the first aspect of the present invention, and further including the steps of receiving the medium dependent description transmitted in the determined medium, transmitting in a second medium a medium dependent description of a reply, receiving the medium dependent description of the reply, translating the received medium dependent description of the reply to a medium independent description of the reply, and updating the cause of the at least one trigger by acting upon instructions contained in the medium independent reply. In an embodiment of this aspect of the present invention the second medium is the same as the medium used to transmit the medium dependent description of the notification to the user. In other embodiments of the present aspect of the invention the second medium is different from the medium used to transmit the medium dependent description of the notification to the user, and the step of updating optionally causes another notification to be generated and transmitted in the second medium.

In a further aspect, there is provided a system for medium independent notification of a user via a user notification device comprising at least one data source, operatively connected to a medium independent processor, said processor for determining when a notification should be transmitted, based upon the state of the at least one data source, and for generating a medium independent description of a notification message, said processor operatively connected to medium independent description to medium dependent description translator, said translator for receiving as an input a medium independent description of a notification and for providing as an output a medium dependent description of a notification, and at least one medium processor, operatively attached to the at least one translator for translating the medium dependent description of the notification message to the user notification device. In an embodiment of the present aspect there is a user preferences table operatively connected to the medium independent processor for selecting one of the at least one translators to translate the medium independent description of the notification into a medium dependent description of the notification.

In yet a further aspect of the present invention, there is provided a system for medium independent notification of a user via a user notification device comprising the elements described in the previous aspect, and further including at least one second medium processor for receiving a medium dependent description of a reply from the user notification device, at least one medium dependent description to medium independent description translator operatively connected to the at least one second medium processor, said translator for receiving and translating a medium dependent description of the reply to a medium independent description of the reply, and operatively connected to the medium independent processor, for providing the medium independent processor the medium independent description of the reply and an action processor, operatively attached to the medium independent processor and the at least one data source, for acting upon instructions contained in the medium independent description of the reply, the instructions received by said action processor from the medium independent processor, and for modifying the state of the at least one data source. In embodiments of the present aspect there are a plurality data sources, a medium independent processor that generates an extensible markup language based medium independent description of the notification message, a plurality of medium independent description to medium dependent description translators which can be uniquely associated with a plurality of medium processors, said translators and processors optionally being combined into a medium independent description to medium dependent processor. Other embodiments of the present invention include a plurality of second medium processors which can be uniquely associated with to a medium dependent description to medium independent description translator, said medium dependent description to medium independent description translator optionally being combined into a medium dependent description to medium independent description processors. In alternate embodiments the second medium processor and the at least one medium processor are the same. In another alternate embodiment the at least one second medium processor receives a medium dependent description of a reply from a user notification device, wherein the user notification device is distinct from the notification device to which the medium dependent description of the notification message is transmitted.

In another aspect of the present invention there is provided a medium independent description to medium dependent description translator comprising an input for receiving the medium independent description, a description processor, operatively connected to the input, for associating elements in the medium independent description to elements in the medium dependent description, and for generating a translation of the medium independent description into the medium dependent description based on the association of the elements and an output, operatively connected to the description processor for providing the medium dependent description generated by the description processor. Additionally there is provided a medium dependent description to medium independent description translator comprising an input for receiving the medium dependent description, a description processor, operatively connected to the input, for associating elements in the medium dependent description to elements in the medium independent description, and for generating a translation of the medium dependent description into the medium independent description based on the association of the elements and an output, operatively connected to the description processor for providing the medium independent description generated by the description processor.

Another aspect of the present provides a method of translating between a medium independent description and a medium dependent description comprising creating an association between elements in the medium independent description and elements in the medium dependent description, examining either the medium dependent description, or the medium independent description to identify elements and translating the identified elements based on the created association between elements. In embodiments of the present aspect elements in the medium independent description that cannot be associated with elements in the medium dependent description not translated during the step of translating, and elements in the description s are defined by fields in a markup language.

### BRIEF DESCRIPTION OF THE DRAWINGS

Preferred embodiments of the present invention will now be described, by way of example only, with reference to the attached figures, wherein:

FIG. 1 is an illustration of an embodiment of the system of the present invention;

FIG. 2 is a flowchart illustrating a method of the present invention;

FIG. 3 is a flowchart illustrating a method of the present invention; and

FIG. 4 is an illustration of an embodiment of a translator of the present invention.

### DETAILED DESCRIPTION OF THE INVENTION

This description makes reference both to medium dependent and medium independent descriptions, medium dependent processors and medium independent processors. In the context of this description, medium refers not to the communications channel, but instead to the communications system. That is to say that medium independence refers to a format designed to work with numerous communications systems, such as facsimile, page, e-mail and telephone (both landline and wireless), regardless of the physical channel that is used.

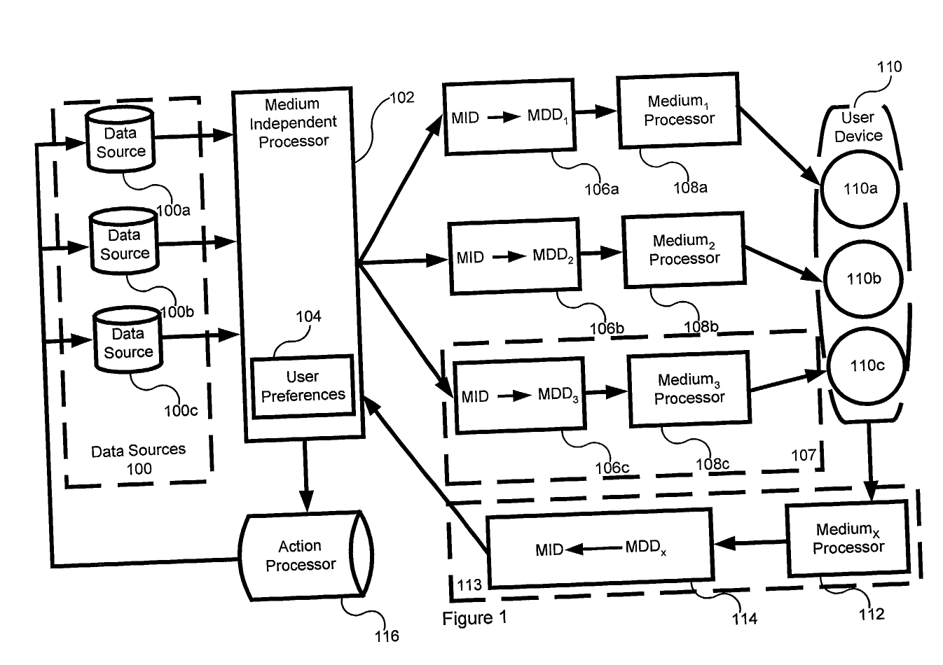

A dialogue is an interaction between a human user and a processing system that consists of notifications and replies. The notifications and replies are generically referred to as interactions. Each interaction conveys information to either the user or system. Some replies will signify that the user wishes to move to a new interaction, while some will indicate that the user wishes to end the dialogue. Other interactions will result in a new value being associated with a data source. This new value, or a value derived therefrom, may then be dynamically inserted into the next interaction. The system illustrated in FIG. 1 issues notifications to a user, based on the state of at least one data source, over a variety of media, and receives replies from the user that can be acted upon to change the state of the data sources.

FIG. 1 illustrates an embodiment of a system of the present invention that provides multiple media for a given message, and provides the ability to allow the user to interact with the system and respond to notifications via at least one user notification device. It should be noted that FIG. 1 is only an exemplary embodiment of the present invention and as such should not be considered limiting to the scope of the invention.

In FIG. 1, at least one data source 100, such as, for example, a database with inventory information, a digital temperature gauge, a clock, or a dynamically updated stock price table, is connected to a medium independent processor 102, typically comprised of a software application program for monitoring the state of the data source 100 and generating messages based on the state of the data source, running on conventional computer hardware. The medium independent processor 102 uses the at least one data source 100 to determine when a notification message should be transmitted. The state of the data source 100 could be, for example, the number of a given product in the inventory, the temperature that a gauge reports, the price of a given stock in a table, or any other information stored or values derived from the information stored, or presented by the data source. The data source 100 can trigger a notification by alerting the medium independent processor 102 to its state, by means of an interrupt, or the data source 100 can be polled by the medium independent processor 102. As one of skill in the art will understand, where reference has been made to one method, the other, or any equivalent method may be used. When a change in the state of a data source 100 results in a condition that requires a notification, the medium independent processor 102 examines the state of the particular data source 100, and the state of any other data sources 100, and determines the particular notification message to be transmitted. The notification message, generated by the medium independent processor 102, is created in a medium independent description (MID) format. The specific formation of the MID can easily be varied from implementation to implementation, but, in the present embodiment, an extensible markup language (XML) format is used. The present embodiment uses an XML format that is a superset of the formats it can be translated into. Thus, the XML format for the MID of a notification contains all fields and features that are used by any of the formats that the MID of a notification could be translated into.

Because the MID format is not necessarily designed to be presented in a particular format, it is provided to a MID-to-medium dependent description (MDD) format translator 106. The particular translator 106 used is determined by user preferences that are stored in a user preferences table 104. Table 104 is optional, as the system may be implemented without it, or it may be considered as another data source 100. The table 104 is read by the medium independent processor 102 prior to transmitting the MID notification to determine which translator 106 the MID notification is sent to. Because the translator 106 for a given medium is designed to look for only particular fields in the MID notification, adding new functions and fields to the MID format allows the medium independent processor to support new features and fields without impairing backwards compatibility with existing MDD formats, as existing translators will ignore the new fields. Various MDD formats can be supported, a non-exhaustive list of MDD formats includes hypertext markup language (HTML), wireless markup language (WML), voice extensible markup language (VXML) which can be used to control IVR's, wireless application protocol binary extended markup language (WBEML), handheld device markup language (HDML), as well as a variety of proprietary formats. After the translator 106 creates an MDD notification, the MDD notification is provided to the medium processor 108. The medium processor 108 then causes a notification on the user notification device 110. The notification can be by means such as e-mail, on a number of platforms, a voice notification, wherein an IVR audibly presents a message, or a facsimile transmission. The medium processor 108 can be anywhere on the network between the translator 106 and the user notification device 110. In the case of an IVR, processor 108 is typically tangibly distinct from the user notification device 110, which would be a phone. This is, however, not always the case. For example, an HTML compliant browser can act as the processor 108 of an HTML message, and is a software application program executed by the user notification device 110, which is a general purpose computer. Upon receiving the MID notification, the translator 106 extracts all fields in the MID notification that have equivalents in the MDD. The values from the extracted fields are put into an MDD notification that will be understood by the medium processor 108. It is possible to integrate the functionality of the translator 106 and the medium processor 108. It is possible to have, for exemplary purposes, a VXML based IVR that serves as a medium processor, but accepts the MID notification and translates the pertinent fields from the MID notification into their MDD equivalents, on the fly.

In order to provide interactivity, the notification provided to the user notification device 110 can be replied to. In one embodiment, the notification presented by the user notification device 110 contains prompts, which allow the user to reply via a selection of a series of predefined actions. The selection of one of the predefined series is received as an MDD reply by a second medium processor 112 and transmitted to an MDD-to-MID translator 114, which could optionally be integrated with the medium processor 112. A combination of the second medium processor 112 and the MDD-to-MID translator 114 is referred to as an MDD-to-MID processor 113. The resulting MID reply is provided to the medium independent processor 102. In certain instances the medium independent processor 102 would then create a new notification that would be transmitted in the same manner as the original notification was. In other instances the medium independent processor 102 would interact with the action processor 116 which can act upon instructions provided in the MID. The action processor 116, typically a general-purpose computer running software application programs designed to interact with external systems, is designed to receive input from the medium independent processor 102. Such external systems can include heating ventilation and air conditioning (HVAC) control systems, order placement systems, and other systems related to regulating the state of the data sources 100. For example, the action processor 116 could allow the implementation of an option to replenish an inventory, upon a notification that the number of a given product in stock has fallen below a threshold. The MDD-to-MID translator 114 can alternatively be viewed as a data source 100, where the medium independent processor 102 is triggered into another notification, based on the reply by the user, which alters the state of the data source. In such an instance, the action processor 116 can also be considered an MID-to-MDD 106 translator that simply translates a notification into a format that is acted upon by an outside agent instead of being transmitted to a user notification device 110, such an action would have the ability to change the state of the data sources 100. In an alternate embodiment, the medium independent processor 102 creates a session for every notification that is generated, and replies from the user 110 via the MDD-to-MID translator 114 are treated as a part of the same session, with new notifications being transmitted based solely upon the MID reply provided.

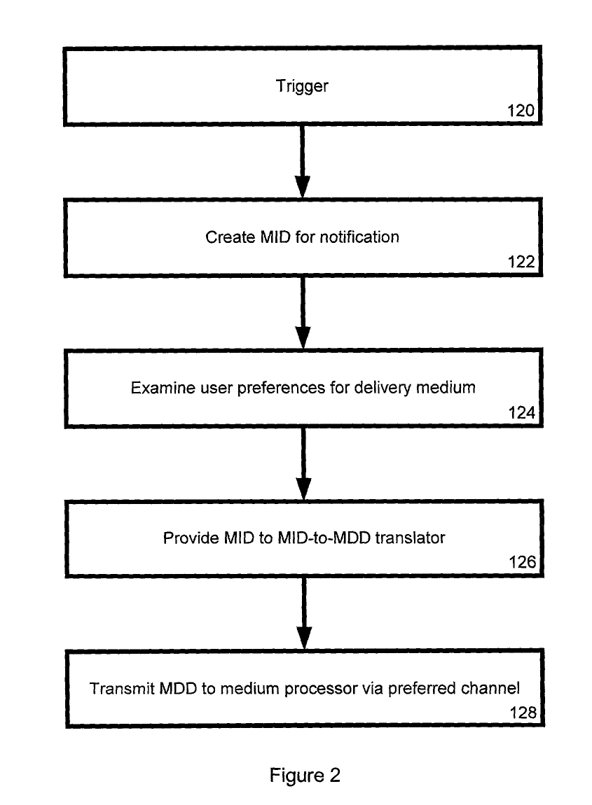

FIG. 2 illustrates a method of the present invention, by which a MID of a notification is generated and provided to the user 110 as a MDD of a notification. In step 120 a trigger activates a notification. The trigger may be any number of factors such as temperature of a system exceeding a threshold, volume of merchandise falling below an acceptable level, any other such condition that can be monitored by a system such as a medium independent processor 102, or a user request to initiate a notification. A trigger may be generated by the data source 100 upon reaching a threshold, or may be generated by the medium independent processor 102 upon polling the data source 100 and finding a threshold has been reached. After a notification has been triggered, an MID notification is generated at step 122. After the MID notification, specific to the trigger has been generated, the user preferences are examined to determine which delivery medium is to be used in step 124. The medium independent processor 102 then locates the user preferences in the user preferences table 104, and routes the MID notification to the MID-to-MDD translator 106 in step 126. The translator 106 transmits the MDD notification to the medium processor 108 in step 128. The MDD notification is then provided to the user notification device 110.

The activation of a trigger in step 120 results in the medium independent processor 102 examining the state of all data sources 100 to determine what the exact condition causing the trigger is. As a result, different notifications can be generated, subject to different conditions, and for a given user profile, each distinct notification can have a different preferred delivery medium.

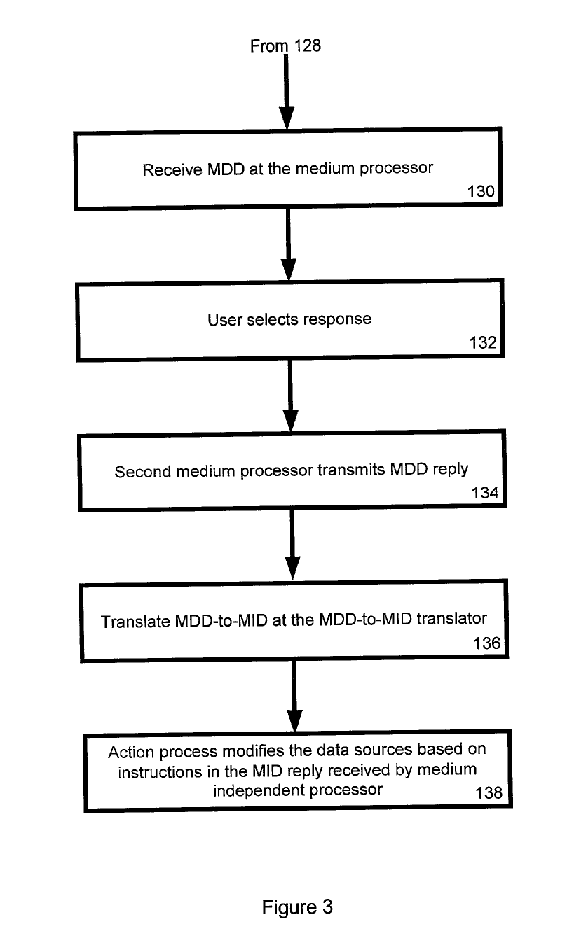

FIG. 3 illustrates additional steps in the method of the present invention wherein the user responds to the notification via the user notification device 110. After the translator 106 transmits the MDD notification to the medium processor 108, the user notification device 110 receives the MDD notification in step 130. The user is typically presented with a set of predetermined options, each of which are associated with a series of actions. The user then chooses one of the options 132 and an MDD reply is transmitted 134 by the user notification device 110. The MDD reply is translated to a MID reply in step 136 and the MID reply is provided to the medium independent processor 102. The medium independent processor 102 instructs the action processor 116 to update the data sources 100 or to act on an external situation. This changes the causes of the trigger based on instructions in the MID reply 136. It is not essential that the MDD reply be in either the same MDD format, or over the same medium as the MDD notification, though in many simplified examples this is the case for ease of explanation.

The above described system and method offer a flexible notification system that can transmit using multiple media channels, and can accept replies over the same channels. The advent of new distribution channels does not necessitate the creation of a new set of send and reply engines, simply a new translator, and potentially the expansion of the feature set of the MID format.

For exemplary purposes a description of a medium independent description format is provided below. This description is meant to be exemplary in nature and should not be construed as limiting in scope. One of skill in the art will recognize that numerous variations on the implementation are possible while remaining within the scope of the present invention.

Medium dependent descriptions often use standard notations to describe an interaction. In this case, the medium processor 108 is usually a standard piece of software that knows how to process these standard descriptions. An example, would be HTML (the medium dependent interaction description notation) and an HTML compliant browser. However, the method also allows for the use of proprietary notations and processors.

A media independent description consists of a set of interaction descriptions. Each interaction description defines a set of prompts, fields, and buttons. Buttons are associated with an interaction (i.e. the interaction to perform if the button is selected). A dialogue has an initial interaction that defines where the dialogue begins. If a button has no associated interaction, the dialogue stops.

A prompt is characterized by the text that is to be conveyed by the processing system to the user.

A field has a number of characteristics. The field can have a name by which it is known by the processing system. A field can have an initial value. A field can have a data type that is character or numeric. A character field can contain any characters while a numeric field is restricted to characters and sequences that define a number. A field can have a minimum and maximum length. A field can have a style that defines how a user might provide a value. A style can be “entry” that means the user must simply provide a value; “option” that means the user must select from a list of possible values; or “hidden” that means the field is not visible to the user. An option, in fact, has both a prompt value and a value. The prompt value is what is conveyed to the user when the options are enumerated. The value is the actual field value to be associated with the field when the user selects the specific option. Finally, a field may be hidden which means the value is not conveyed to the user.

A button has a prompt (what is conveyed to the user) and an associated interaction. When a user selects a button (the meaning of selects depends on the actual medium and can be, for example, a voice reply, depressing a key, or clicking an icon with a mouse or other input device), the user indicates that he/she wishes to move to the indicated interaction. If a button has no associated next interaction, the dialogue stops. In more detail, a button has a “method” and “next interaction” address that defines the next interaction. Method indicates how the next interaction will be accessed and may have values of GET or POST (corresponding to typical methods used with Web Servers). Buttons also have a “name” and a “type”. The name would be used to visually identify the button in environments where the button is visible. The type can be “accept” or “other”. Accept means that values associated with user input are accepted and sent to the next interaction associated with the button. Other means that an alternative interaction is to be selected and user input is ignored.

Fields and prompts are associated with buttons. A button of type “other” may only have fields of style “hidden” associated with it. It may not have any prompts either. There must be at most one accept button. While this may sound like a limitation, it actually fits the requirements of real dialogues very well. “Other” buttons typically are used to navigate around a dialogue—to go back to the beginning or to go to some specific point in the dialogue.

Note that not all attributes are required. For example, if no value attribute is provided for a field, then it will not have an initial value.

An example is now presented, with reference to the elements of FIG. 1, making use of a variety of data sources 100 including an inventory control system and a clock. The notification will be transmitted to multiple recipients over a variety of media, and the action processor 116 will resolve the scenario by taking external actions and changing the state of at least one data source.

An example was introduced above, wherein a purchasing manager would need to be notified in the event that the quantity of a given product in stock dropped below a threshold. In this exemplary case, inventory is tracked by a first data source 100a, in the form of a conventional inventory database, a second data source 100b maintains information about all inventory orders that have not arrived, in the form of a conventional orders database, and a third data source 100c is a clock/calendar that provides time and date information. A notification is triggered by the first data source 100a when the inventories of a stress reliever fall below 100 units. The medium independent processor 102 responds to the trigger by examining all data sources 100.

Data source 100b indicates that no order has been placed to replenish the stock of stress relievers, and data source 100c indicates that this situation is occurring between the hours of 1:00pm and 5:00pm. This information is used by the medium independent processor 102, to create a notification in the MID format. In conjunction with the user preference table 104, it is determined that an electronic mail message should be sent to the purchasing manager's office e-mail account. Thus, translator 106a is used to translate the MID notification to an MDD notification. Because the notification is being sent via e-mail to the office account, the MDD format can be HTML, plaintext or any other format suitable for transmission via email, as one of skill in the art will appreciate. After transmitting the MDD notification to the medium processor 108a, the medium independent processor 102 awaits a reply. After a predetermine amount of time, the clock/calendar 100c triggers another notification with the states of the first and second data sources 100a & 100b unchanged (no orders have been placed or received in the interim). The user profile table indicates that if the first notification was not replied to and/or resolved, the second notification should be transmitted as an e-mail message to a mobile device account associated with the purchasing manager's handheld computer. No reply is received to the first e-mail notification. Once again, a MID notification is prepared by the medium independent processor 102. Because the e-mail message is being sent to a handheld device, the message is translated to HDML by the MID-to-MDD translator 106b and transmitted to the medium processor 108b.

After another time interval has elapsed, without a reply being received, the medium independent processor 102 is once again triggered by the clock 100c. The notification is prepared, and the user preference table 104 is examined. For the third notification, the user preference table 104 indicates that an IVR message should be transmitted to the assistant purchasing manager, because it can be assumed that the purchasing manager is unavailable. The user preference table 104 further indicates that since it now after 5:00pm the assistant purchasing manager should be contacted on a cellular phone. The MID notification is transmitted to translator 106c which converts the MID notification into a VXML MDD notification which is used by the medium processor 108c, an IVR system, to place a call to the provided phone number. The user notification device 110c, a cellular phone, rings, is answered, and provides the notification to the assistant manager. The notification that the supply of stress relievers is low is part of the prompt. Additionally, the assistant purchasing manager is presented with the options to ignore the warning and set a new alert threshold for stress relievers; order a new supply of stress relievers; and to disable any further stress reliever related notifications. If the first option is selected, the cellular phone transmits a dual tone multiple frequency (DTMF) touch tone signal to the medium processor 112, which in this instance is the same as the medium processor 108c, the IVR. The IVR transmits the MDD reply (the DTMF) signal to the MDD-to-MID translator 114, which in turn provides an XML based MID reply to the medium independent processor 102, which then uses the same process it did to activate the notification to issue a secondary request to the assistant purchasing manager to determine what the new threshold should be. If the initial phone call has not been terminated, the IVR 108c does not need to re-initiate the call, but simply presents a new prompt in the same session. The second prompt allows the assistant purchasing manager to set a new threshold, which is transferred to the medium independent processor 102 in the same manner as before. This would complete the session, though there may be a final message transmitted to the assistant purchasing manager to notify him of the completion of the transaction.

If the assistant purchasing manager chose the second option, to order new supplies of stress relievers, the DTMF signal would be received by the IVR 112, converted to an MID reply by the translator 114 and provided to the medium independent processor 102. The medium independent processor 102 would then issue a second notification, in the same session if the call was not disconnected, or by initiating a new call if it was, requesting the number of items that should be ordered. A touch tone response, indicating the number of units to order is then received by the medium processor 112, translated to an MID format by the translator 114, and provided to the medium independent processor 102. The medium independent processor 102 then provides instructions to the action processor 116 based on the instructions provided in the MID second reply. The action processor 116 then updates the second data source 100b to reflect the fact that stress relievers are on order, and then contacts the supplier of the stress relievers to order more. The contacting of the supplier can be done in any number of ways, as one of skill in the art will appreciate. In the present embodiment the action processor 116 includes a general-purpose computer having the ability to generate and transmit facsimile messages. Thus, to place an order for more stress relievers, the action processor 116 creates a purchase order and transmits it to the supplier via facsimile. Upon notifying the action processor 116 of the actions to be undertaken, medium independent processor 102 transmits a goodbye notification to the signal the completion of the transaction. The goodbye notification optionally includes information regarding the transactions undertaken by the action processor 116, as a result of the responses.

If at this point the purchasing manager retrieves one of the first two alerts, and begins an interaction with the medium independent processor 102, the medium independent processor 102 would generate, as its notification in response to the reply, an MID notification that indicates that a given number of stress relievers are on order and that the situation had been resolved at a given time by the assistant purchasing manager. In an alternate embodiment of the present invention the MID notification sent to the IVR 108c would contain all the different branches that the call could have followed, expanded, so that the interaction with the medium independent processor 102 would be limited to just the instructions on the resolution of the situation. This embodiment would require less overhead, and would reduce the bandwidth required for communications between the IVR 108 and the medium independent processor 102.

In a second example, a data source 100a is a conventional web server. This server allows a first user to login and select a list of users to whom a message will be sent. The first user selects a group of people, an initial message, such as an invitation to dinner, and an acceptable list of replies, such as yes or no. Upon this information being received, a trigger is generated, and the medium independent processor 102 begins to create an MID notification. The medium independent processor 102 determines how each notification will be delivered in conjunction with a clock, which serves as an additional data source 100b. After determining that, at the current time, the first recipient requires a short message service (SMS) notification, the medium independent processor 102 transmits the MID notification to the translator 106a, which provides an SMS message to an SMS gateway which serves as medium processor 108a. The SMS gateway 108a transmits the SMS notification to the user notification device 110a. Upon receiving the SMS notification, the first recipient replies via an SMS reply to the second medium processor 112, a second SMS gateway, which forwards an MDD reply to the translator 114, which in turn provides an MID reply to the medium independent processor 102. The medium independent processor 102 analyzes the response and gives instructions to the action processor 116. The action processor 116 then updates data source 100c, a database used to track replies to the transmitted notification.

The second recipient, due to the time and date, prefers e-mail notification on a cellular phone, so the medium independent processor 102 provides the MID notification to translator 106b, which provides medium processor 108b with a WML message that is transmitted to the second recipient's cellular phone, user notification device 110b. The second recipient then clicks through the message and transmits, through second medium processor 112, a WML reply to the email notification. The WML reply is translated to an MID reply by translator 114 and is provided to medium independent processor 102. Medium independent processor 102 instructs action processor 116 to update data source 100c to reflect the reply. Further notifications are transmitted, in series or in parallel, until the list of invitees is exhausted. Updates are made to data source 100c by the action processor 116 as replies are received. Upon receipt of replies from the complete list, or at a time specified by the first user, a notification message is generated, containing the replies to the invitation or the replies received thus far as the case may be. This notification, encapsulated in an MID format, is translated by translator 106a into a SMS notification. The notification is provided to an SMS gateway 108a and is transmitted to the first user, informing the first user that an enclosed list of people had accepted the dinner invitation.

As previously described, it is within the scope of the present invention for an initial notification to be delivered to the user using a first medium, and for the balance of the dialogue to be held using another medium. This is a result of the medium independent processor 102 using a medium independent description language so that a dialogue on any given medium appears identical to the same dialogue on any other medium to the medium independent processor 102. In a present embodiment it is possible for a dialogue started on a first medium to be interrupted at any point and later resumed using any medium, be it the same medium originally used or another, without requiring that the initial stages of the dialogue be repeated.

An example using the elements of FIG. 1 is now presented for exemplary purposes. Medium independent processor 102 determines that a notification should be generated due to the state of data sources 100. An MID notification is generated for a user, and the user preferences table 104 is consulted to determine the medium to be used. The user preferences table 104 indicates that a telephone call made by an IVR is the preferred delivery medium, so the MID is provided to the MID-to-MDD translator 106a. The translator 106a translates the MID into VXML for medium processor 108a, a VXML based IVR. IVR 108a places telephone call to user device 110a, a cellular phone, and transmits the first notification to the user. The user, using cellular phone 110a, enters into a dialogue by transmitting DTMF signals to the medium processor 112 in response to the notification, In this instance medium processor 112 is the same as medium processor 108a. The medium processor 112 receives the DTMF signals and provides them to translator 114. Translator 114 provides an MID reply which is provided to the medium independent processor 102. After a number of such transactions cellular phone 110a is disconnected, without completing the dialogue. This disconnect can be for any number of reasons, such as a low battery condition, cellular network difficulty, or other reasons known to one of skill in the art. Depending upon the state of the data sources 100, the medium independent processor 102 could alert another individual after a predetermined timeout, or it could wait for either a change of state to the data sources 100 or for the user to re-initiate the connection and resume the dialogue. To resume the dialogue the user directs user device 110b, a personal computer using an HTML compliant web browser, to contact the medium independent processor through a second medium processor 112. The HTML-based information to medium processor 112 is translated into an MID reply by second translator 114. The MID reply is provided to medium independent processor 102. Medium independent processor 102, upon recognizing the connection as being from the user of the aborted dialogue, generates the next notification in the dialogue, and transmits it to translator 106b, which provides medium processor 108b with HTML to be transmitted to user device 110b so that the resumed dialogue can be completed without further interruption.

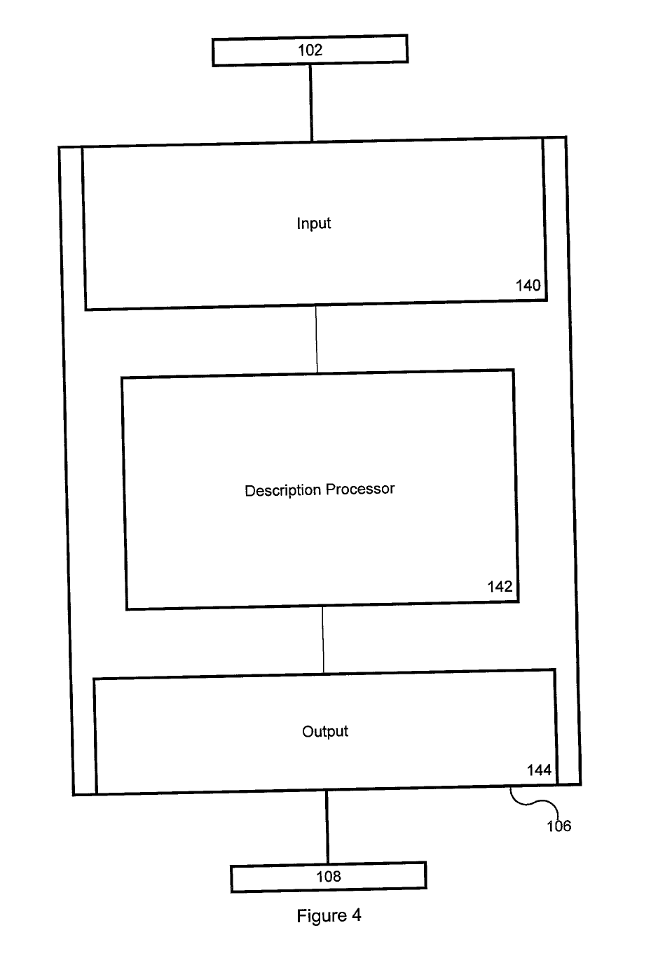

One of skill in the art will appreciate that there are a number of ways that translator 106 or translator 114 can be implemented. In a preferred embodiment, shown in FIG. 4, translator 106 is designed with an input 140, to receive the MID. The input 140 is connected to a description processor 142. The description processor 142 associates elements in the MID to elements in the MDD. Using these associations, the description processor 142 can translate between the MID and the MDD. Where there is an element in the MID that is not present in the MDD, the description processor 142 does not include a translation for it (functionally this can be thought of as a mapping to a null set). The description processor 142 provides the translation to the output 144 which allows transfer of the MDD to any connected system. If the MID is an XML based language, then the elements of the MID are fields. Similarly if the MDD is a markup language, the elements of the MDD are also fields. As will be apparent to one of skill in the art a translator to translate from and MDD to the MID, such as translator 114, can be constructed in a similar fashion, and does not need to deal with functions in the MDD that are not present in the MID. It should be apparent to one of skill in the art that a translator such as translator 106 can be used in a number of systems other than the one illustrated in FIG. 1.

The above examples are intended to illustrate the breadth of functionality of the present invention and should not be considered as an exhaustive list of the applications of the present invention. As illustrated above, the use of a format independent root format allows the present invention to mitigate the disadvantages of the prior art. The format independent root allows the present invention to support new features and distribution media, as they become available, without having the worry about backwards compatibility. A new medium requires the development of a single translator, and then can be used for bi-directional communications, a solution that requires far less development time that a conventional system would, especially if the new medium supported new features, or was not controllable via a language similar to the root format.

The above-described embodiments of the invention are intended to be examples of the present invention. Alterations, modifications and variations may be effected the particular embodiments by those of skill in the art, without departing from the scope of the invention which is defined solely by the claims appended hereto.

What is claimed is:

1. A method of medium independent automated notification of a user, comprising the steps of:
determining, on the basis of at least one trigger, that a notification message should be transmitted;
generating, based upon the state of the at least one trigger, a medium independent description of a notification message;
selecting a medium dependent description, in which the notification message should be transmitted;
translating the medium independent description of the notification into a medium dependent description of the notification; and
transmitting the medium dependent description of the notification to the user via the transmission channel suitable for transmitting the medium dependent description of the notification.

2. The method as in claim 1, wherein the step of selecting the medium dependent description is done based upon a predetermined profile.

3. The method as in claim 2, wherein the predefined profile is specific to the user for whom the automated notification is destined.

4. The method as in claim 1, wherein the step of determining that a notification message should be transmitted is done on the basis of a plurality of triggers.

5. The method as in claim 4, wherein the plurality of triggers are independent of each other.

6. The method as in claim 1, wherein the medium independent description is defined by an extensible markup language.

7. The method as in claim 1, wherein the medium dependent description of the notification is specific to the channel on which it is transmitted.

8. A method of interactive, medium independent, automated notification comprising the steps of claim 1, and further including the steps of:
receiving the medium dependent description of the notification, transmitted via the transmission channel;
transmitting, in a second medium, a medium dependent description of a reply via a transmission channel;
receiving the medium dependent description of the reply;
translating the received medium dependent description of the reply to a medium independent description; and
updating the causes of the at least one trigger by acting upon instructions contained in the medium independent reply.

9. The method as in claim 8, wherein the second medium is the same as the medium used to transmit the medium dependent description of the notification.

10. The method as in claim 8, wherein the second medium is different than the medium used to transmit the medium dependent description of the notification.

11. The method, as in claim 10, wherein upon updating the causes of the at least one trigger, another notification is generated and transmitted in the second medium.

12. A system for medium independent automated notification of a user via a user notification device comprising:
at least one data source;
a medium independent processor, operatively attached to the at least one data source, for determining, based upon the state of the at least one data source, when a notification should be transmitted and for generating a medium independent description of the notification message;
at least one medium independent description to medium dependent description translator, operatively attached to the medium independent processor, for receiving, as input, a medium independent description of the notification message and providing, as output, a medium dependent description of the notification message; and
at least one medium processor, operatively connected to the at least one medium independent description to medium dependent description translator, for transmitting the medium dependent description of the notification message to the user notification device.

13. The system of claim 12, further including a user preferences table, operatively connected to the medium independent processor, for selecting one of the at least one translators to translate the medium independent description of the notification.

14. The system of claim 12, further including:
at least one second medium processor, for receiving a medium dependent description of a reply from the user notification device;
at least one medium dependent description to medium independent description translator, operatively connected to the at least one second medium processor, for receiving and translating a medium dependent description of the reply to a medium independent description of the reply, and operatively connected to the medium independent processor, for providing the medium independent processor the medium independent description of the reply; and
an action processor, operatively attached to the medium independent processor and the at least one data source, for acting upon instructions contained in the medium independent description of the reply, the instructions received by said action processor from the medium independent processor, and for modifying the state of the at least one data source.

15. The system of claim 12, further including a plurality of data sources.

16. The system of claim 12, wherein the medium independent processor generates an extensible markup language medium independent description of the notification message.

17. The system of claim 12, further including a plurality of medium independent description to medium dependent description translators.

18. The system of claim 17, further including a plurality of medium processors.

19. The system of claim 18, wherein each medium independent description to medium dependent description translator is uniquely matched to a medium processor.

20. The system of claim 12, wherein the at least one medium independent description to medium dependent description translator and the at least one medium processor are combined into a medium independent description to medium dependent processor.

21. The system of claim 14, further including a plurality of second medium processors.

22. The system of claim 21, further including a plurality of medium dependent description to medium independent description translators.

23. The system of claim 22, wherein each second medium processor is uniquely matched to a medium dependent description to medium independent description translator.

24. The system of claim 14, wherein the at least one second medium processor and the at least one medium dependent description to medium independent description translator are combined into a medium dependent description to medium independent description processor.

25. The system of claim 14, wherein the at least one second medium processor and the at least one medium processor are the same.

26. The system of claim 14, wherein the at least one medium independent description to medium dependent description translator and the at least one medium dependent description to medium independent description translator are the same.

27. The system of claim 14, wherein at least one second medium processor receives a medium dependent description of a reply from a user notification device, wherein the user notification device is distinct from the notification device to which the medium dependent description of the notification message is transmitted.

28. A medium independent description to medium dependent description translator comprising:
an input for receiving the medium independent description;
a description processor, operatively connected to the input, for associating elements in the medium independent description to elements in the medium dependent description, and for generating a translation of the medium independent description into the medium dependent description based on the association of the elements; and
an output, operatively connected to the description processor for providing the medium dependent description generated by the description processor.

29. A medium dependent description to medium independent description translator comprising:
an input for receiving the medium dependent description;
a description processor, operatively connected to the input, for associating elements in the medium dependent description to elements in the medium independent description, and for generating a translation of the medium dependent description into the medium independent description based on the association of the elements; and
an output, operatively connected to the description processor for providing the medium independent description generated by the description processor.

30. A method of translating between a medium independent description and a medium dependent description comprising:
creating an association between elements in the medium independent description and elements in the medium dependent description;
examining either the medium dependent description, or the medium independent description to identify elements; and
translating the identified elements based on the created association between elements.

31. A method, as in claim 30, wherein, during the step of translating, elements in the medium independent description that cannot be associated with elements in the medium dependent description not translated.

32. A method, as in claim 30, wherein elements in both the medium independent description and the medium dependent description are defined by fields in a markup language.
